(19) United States
(12) Patent Application Publication
(10) Pub. No.: US 2026/0077725 A1
(43) Pub. Date: Mar. 19, 2026

(54) HIGH VOLTAGE COMPONENT DEFLECTOR SHIELD

(71) Applicant: FCA US LLC, Auburn Hills, MI (US)

(72) Inventors: Kedar V. Panday, Auburn Hills, MI (US); Krishnamurthy Hegde, Auburn Hills, MI (US); Derek Chance, Auburn Hills, MI (US)

(21) Appl. No.: 18/886,397

(22) Filed: Sep. 16, 2024

(51) Int. Cl. B60R 16/02; B60K 1/00

(52) U.S. Cl. CPC B60R 16/0215; B60K 1/00

(57) ABSTRACT

A vehicle including a frame supporting an electric drive motor, a high-voltage component attached to a forward end and upper surface of the electric drive motor, and a protection shield attached to the forward end of the electric drive motor at a position forward and spaced apart from the high-voltage component, wherein the protection shield is configured to shield and deflect components of the vehicle that are forced in a direction toward the high-voltage component during a frontal collision of the vehicle.

### FIELD

The present disclosure relates to a high voltage component deflector shield.

### BACKGROUND

This section provides background information related to the present disclosure which is not necessarily prior art.

Vehicles with battery-powered electric drivetrains are becoming increasingly more common, and are undergoing substantial research and development. One challenge being faced during the development of battery-powered electric vehicles (BEV) is that the battery is typically packaged under a floor of the vehicle due to its large size, and electric drive motor critical high-voltage components responsible for operation of the vehicle are typically packaged under a hood of the vehicle, which exposes the high-voltage components to a danger of being damaged in the event that the vehicle experiences a frontal collision. This is undesirable from the standpoint that any damage to a high-voltage component can cause a short in the electric system that can result in loss of high-voltage isolation and prevent shutdown of the battery. Accordingly, it is important that the integrity of the high-voltage components be maintained.

Past attempts to protect the integrity of the high-voltage components included packaging the high-voltage components at locations of the vehicle that provided protection to the high-voltage components, or increasing the complexity of the front-end structure of the vehicle. Oftentimes, however, these locations were difficult to access and made it difficult to service the high-voltage components. Moreover, these hard-to-reach locations increased the complexity of routing high-voltage cables that connected the high-voltage components with the battery pack and other electronic features of the vehicle, and repackaging these components in hard-to-reach locations can lead to increased dimensions of the vehicle or potentially require altering the appearance of the vehicle.

### SUMMARY

This section provides a general summary of the disclosure, and is not a comprehensive disclosure of its full scope or all of its features.

According to a first aspect, there is provided a vehicle that includes a frame supporting an electric drive motor; a high-voltage component attached to a forward end and upper surface of the electric drive motor; and a protection shield attached to the forward end of the electric drive motor at a position forward and spaced apart from the high-voltage component, wherein the protection shield is configured to shield and deflect components of the vehicle that are forced in a direction toward the high-voltage component during a frontal collision of the vehicle.

According to a first aspect, the vehicle may also include a pump assembly attached to the frame at a position forward of the electric drive motor, wherein the protection shield is configured to shield and deflect the pump assembly from contacting the high-voltage component when the pump assembly is forced in the direction toward the high-voltage component during the frontal collision.

According to the first aspect, the protection shield includes a primary panel including an upper section and a lower section.

According to the first aspect, the upper section is connected to the lower section by a connection section, and the upper section is acutely angled relative to the lower section such that the connection section operates as a hinge that permits the upper section to pivot relative to the lower section when contacted by the components of the vehicle that are forced in the direction toward the high-voltage component during the frontal collision.

According to the first aspect, the primary panel includes a first side section that defines a lip and a second side section that includes secondary panel extending outward therefrom.

According to the first aspect, the secondary panel includes a plurality of apertures configured for receipt of a first fastener that secures the protection shield to the electric drive motor.

According to the first aspect, the lower section includes a rearwardly extending flange that includes an aperture configured for receipt of a second fastener that secures the protection shield to the electric drive motor.

According to the first aspect, the vehicle may also include an electric cable provided proximate the high-voltage component, wherein the protection shield is configured to shield and deflect the components of the vehicle that are forced in a direction toward the electric cable during the frontal collision.

According to the first aspect, the protection shield is formed of a rigid metal material.

According to the first aspect, the rigid metal material is steel.

According to a second aspect of the present disclosure, there is provided a vehicle that may include a frame including a first longitudinally extending rail and a second longitudinally extending rail; an electric drive motor positioned between and supported by each of the first and second longitudinally extending rails; a pump assembly attached to one of the first and second longitudinally rails at a location positioned forward of the electric drive motor; a high-voltage component attached to a forward end and upper surface of the electric drive motor; and a protection shield attached to the forward end of the electric drive motor at a position forward and spaced apart from the high-voltage component, and between the high-voltage component and the pump assembly, wherein the protection shield is configured to shield and deflect the pump assembly from contacting the high-voltage component when the pump assembly is forced in a direction toward the high-voltage component during a frontal collision of the vehicle.

According to the second aspect, the protection shield includes a primary panel including an upper section and a lower section.

According to the second aspect, the upper section is connected to the lower section by a connection section, and the upper section is acutely angled relative to the lower section such that the connection section operates as a hinge that permits the upper section to pivot relative to the lower section when contacted by the pump assembly during the frontal collision.

According to the second aspect, the primary panel includes a first side section that defines a lip and a second side section that includes secondary panel extending outward therefrom.

According to the second aspect, the secondary panel includes a plurality of apertures configured for receipt of a first fastener that secures the protection shield to the electric drive motor.

According to the second aspect, the lower section includes a rearwardly extending flange that includes an aperture configured for receipt of a second fastener that secures the protection shield to the electric drive motor.

According to the second aspect, the vehicle may also include an electric cable provided proximate the high-voltage component, wherein the protection shield is configured to shield and deflect the pump assembly that is forced in a direction toward the electric cable during the frontal collision.

According to the second aspect, the protection shield is formed of a rigid metal material.

According to the second aspect, the rigid metal material is steel.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side-perspective view of an example vehicle according to a principle of the present disclosure;

FIG. 2 is an overhead perspective view of a portion of a frame supporting a propulsion system of the vehicle illustrated in FIG. 1;

FIG. 3 is an isometric perspective view of the propulsion system illustrated in FIG. 2 having a high-voltage component and high-voltage component protection shield according to a principle of the present disclosure attached thereto;

FIG. 4 is a front perspective view of the propulsion system illustrated in FIG. 3;

FIG. 5 is a side perspective view of the propulsion system illustrated in FIG. 3; and

FIG. 6 is a side perspective view illustrating deformation of the high-voltage component protection shield relative to the high-voltage component after the vehicle has been involved in a collision event.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

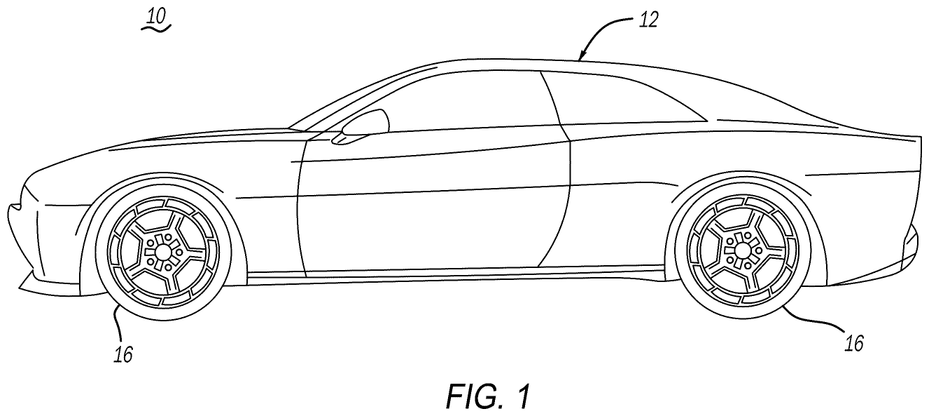

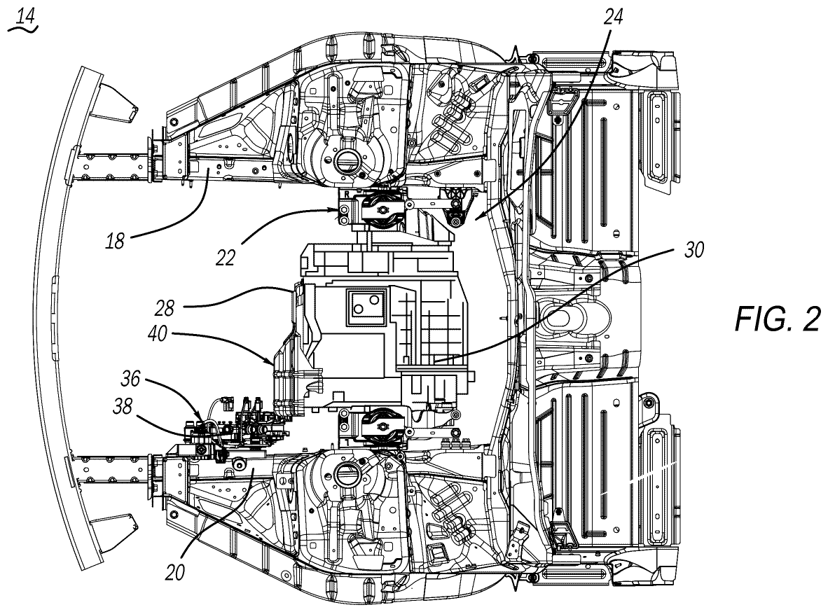

FIG. 1 illustrates an example vehicle 10 according to a principle of the present disclosure. Vehicle 10 includes a body 12 attached to a vehicle frame 14 (FIG. 2), and a plurality of wheels 16.

Now referring to FIG. 2, it can be seen that vehicle frame 14 includes first and second longitudinally extending rails 18, 20 that support a propulsion system 22 of vehicle 10. In the illustrated embodiment, propulsion system 22 is an electric drive module 24 that is positioned between and supported by first and second rails 18, 20. It should be understood, however, that propulsion system 22 may include an internal combustion engine (not shown) without departing from the scope of the present disclosure.

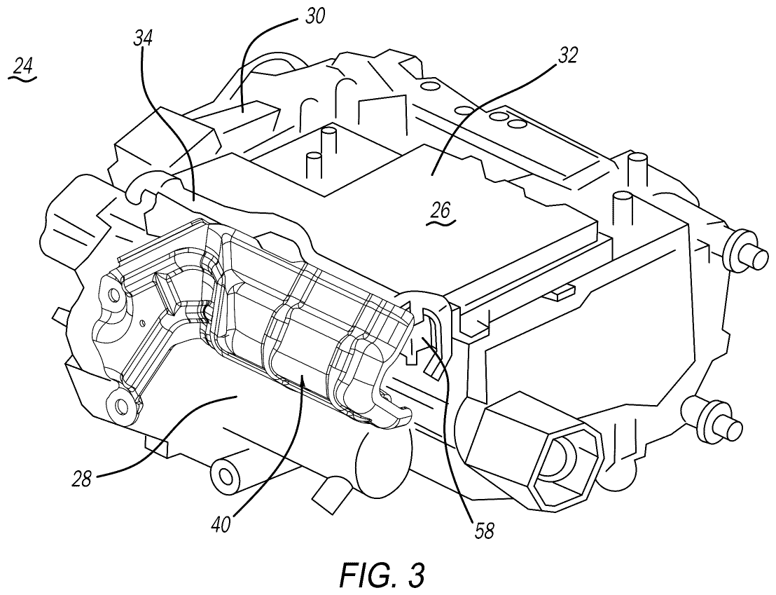

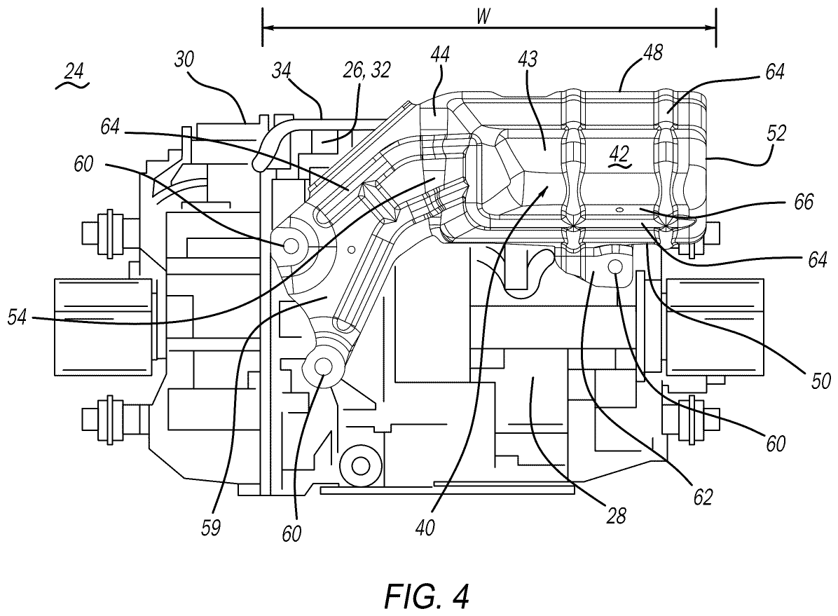

As best shown in FIGS. 3-5, electric drive motor 24 includes a high-voltage component 26 attached to a forward end 28 on an upper surface 30 of electric drive motor 24. High-voltage component 26 may be, for example, a power inverter device that is configured to convert high-voltage direct current (DC) stored in a battery pack (not shown) of vehicle 10 to a high-voltage three-phase alternating current (AC) that can be used to drive the electric drive motor 24. It should be understood, however, that other high-voltage components 26 are contemplated including but not limited to a power distribution center (PDC), an integrated dual charging module (IDCM), an electric air conditioning (EAC) module, and a park distance control (PDC) module without departing from the scope of the present disclosure.

High-voltage component 26 includes a housing 32 that may be formed of a rigid metal material such as cast aluminum, or may be formed of a polymeric material such as polyamide (e.g., NYLON®) or some other material, and which houses a plurality of high-voltage electrical features (not shown) such as electrical circuits and the like. Inasmuch as high-voltage component 26 is located at forward end 28 of electric drive motor 24 due to packaging restraints of vehicle 10, however, high-voltage component 26 may be at risk to be damaged if vehicle 10 is subjected to a collision event with, for example, another vehicle or another object. That is, if high-voltage component 26 is subjected to contact with another component of vehicle 10 during a collision event, housing 32 may crack and expose the high-voltage electrical features, which is undesirable. Moreover, if cracks or sharp edges develop in housing 32 as a result of the collision event, the sharp edges may contact other high-voltage features of electric drive motor 24 such as high-voltage cables 34 that are positioned near high-voltage component 26, which can cut or sever the cables 34. This is undesirable from the standpoint that any damage to a high-voltage component 26 or cables 34 can cause a short in the electric system that can result in loss of high-voltage isolation and prevent shutdown of the battery (not shown).

For example, again referring to FIG. 2, it can be seen that rails 18 and 20 can be used to support other features of vehicle 10 including, but not limited to, a pump assembly 36 having a rigid (e.g., metal) shell 38 that includes various pumps (not shown) and sensors (not shown). As shown in FIG. 2, because pump assembly 36 is located forward of electric drive motor 24, it is possible for pump assembly 36 to be forced in a rearward direction (i.e., back toward electric drive motor 24) if vehicle 10 is subjected to a frontal collision with another vehicle or an object. If pump assembly 36 is forced back with enough force that pump assembly 36 contacts high-voltage component 26, the contact between pump assembly 36 and high-voltage component 26 may, as noted above, cause housing 32 of high-voltage component 26 to crack, which is undesirable.

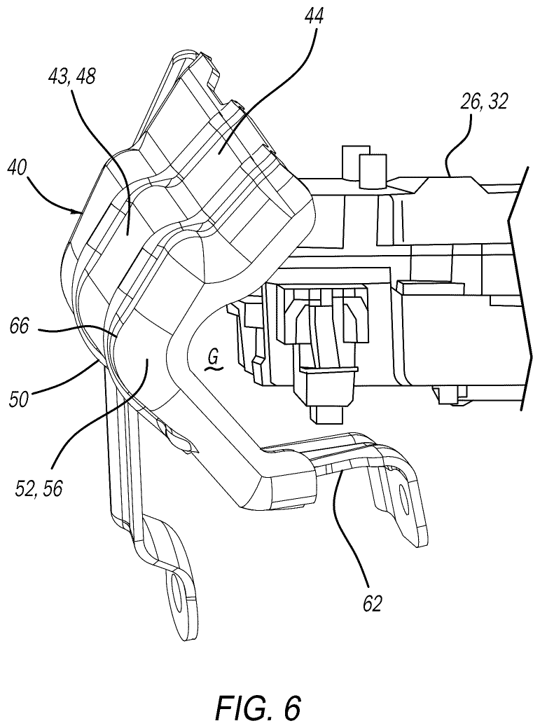

With the above in mind, it can be seen in FIGS. 2-6 that vehicle 10 includes a protection shield 40 attached to electric drive motor 24 at forward end 28 that provides protection and shields high-voltage component 26 from contact with, for example, pump assembly 36 or other components that may be provided near high-voltage component 26 during a frontal collision event. Protection shield 40 may be formed of a rigid material such as steel, and is spaced apart from high-voltage component 26 such that in the event a component such as pump assembly 36 makes contact therewith during a frontal collision event, the protection shield 40 can absorb at least some of the force and deform (FIG. 6). Moreover, protection shield 40 can deflect a component away from high-voltage component 26. In either case, high-voltage component 26 can be completely protected, or at least damage to high-voltage component 26 can be substantially minimized.

Protection shield 40 may be a monolithic member 42 having a front surface 44 that faces away from forward end 28 of electric drive motor 24 and a rear surface 46 that faces forward end 28. Monolithic member 42 includes primary deflection panel 43 having an upper section 48, a lower section 50, and a first side section 52, and second side section 54.

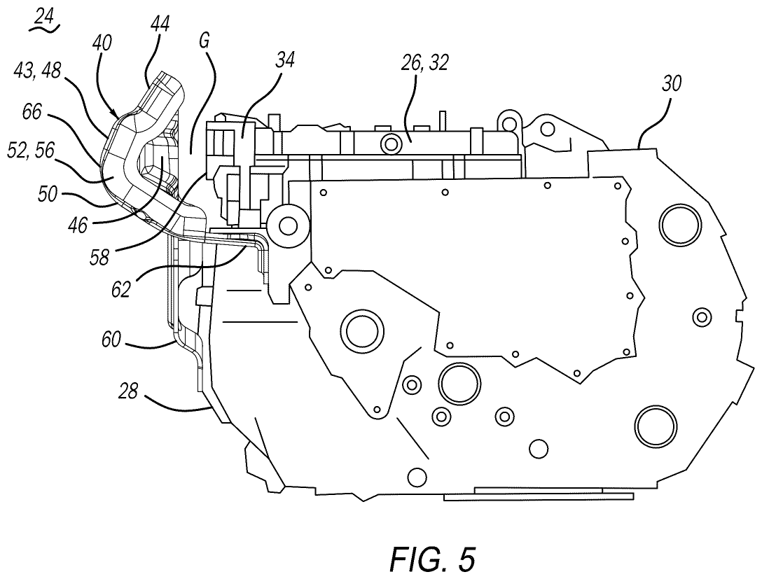

As best shown in FIG. 5, first side section 52 defines a lip 56 that can provide protection (e.g., shield) a front left corner 58 of high-voltage component 26. A secondary panel 59 having pair of apertures 60 provided therein extends laterally outward from second side section 54. Apertures 60 are configured for receipt of a fastener (not shown) that can attach protection shield 40 to electric drive motor 24. Similarly, a rearwardly extending flange 62 attached to lower section 50 that includes another aperture 60 configured for receipt of a fastener extends back toward electric drive motor 24. Use of flange 62 assists in maintaining a gap G (FIG. 5) between rear surface 46 of protection shield 40 and high-voltage component 26 and cables 34.

Panel 42 has a width W that is substantially equivalent to a width of high-voltage component 26. In addition, panel 42 may include a plurality of strengthening ribs 64 that increase the rigidity of panel 42 such that panel 42 is configured to absorb a greater force in comparison to a panel 42 that does not include ribs 64.

As best shown in FIG. 5, upper section 48 and lower section 50 may be angled relative to one another, and connected at a connection section 66. An angle between upper section 48 and lower section 50 may lie in the range of thirty degrees and sixty degrees, and is preferably about forty-five degrees. Connection section 66 may act like a hinge and permit upper section 48 to deform relative to lower section 50 when contacted by a vehicle component such as pump assembly 36. Indeed, as can be seen in FIG. 6, upper section 48 is designed to deform relative to lower section 50 upon being forcefully contacted with a vehicle component such as pump assembly 36. Put another way, upper section 48 is designed to deform to reduce the size of gap G between protection shield 40 and high-voltage component 26. In addition, it can be seen that flange 62 is also designed to deform, at least to some extent, when protection shield 40 is forcefully contacted by pump assembly 36 or some other vehicle component during a frontal collision event.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a frame supporting an electric drive motor;
a high-voltage component attached to a forward end and upper surface of the electric drive motor; and
a protection shield attached to the forward end of the electric drive motor at a position forward and spaced apart from the high-voltage component,
wherein the protection shield is configured to shield and deflect components of the vehicle that are forced in a direction toward the high-voltage component during a frontal collision of the vehicle.

2. The vehicle according to claim 1, further comprising a pump assembly attached to the frame at a position forward of the electric drive motor, wherein the protection shield is configured to shield and deflect the pump assembly from contacting the high-voltage component when the pump assembly is forced in the direction toward the high-voltage component during the frontal collision.

3. The vehicle according to claim 1, wherein the protection shield includes a primary panel including an upper section and a lower section.

4. The vehicle according to claim 3, wherein the upper section is connected to the lower section by a connection section, and the upper section is acutely angled relative to the lower section such that the connection section operates as a hinge that permits the upper section to pivot relative to the lower section when contacted by the components of the vehicle that are forced in the direction toward the high-voltage component during the frontal collision.

5. The vehicle according to claim 3, wherein the primary panel includes a first side section that defines a lip and a second side section that includes secondary panel extending outward therefrom.

6. The vehicle according to claim 5, wherein the secondary panel includes a plurality of apertures configured for receipt of a first fastener that secures the protection shield to the electric drive motor.

7. The vehicle according to claim 6, wherein the lower section includes a rearwardly extending flange that includes an aperture configured for receipt of a second fastener that secures the protection shield to the electric drive motor.

8. The vehicle according to claim 1, further comprising an electric cable provided proximate the high-voltage component, wherein the protection shield is configured to shield and deflect the components of the vehicle that are forced in a direction toward the electric cable during the frontal collision.

9. The vehicle according to claim 1, wherein the protection shield is formed of a rigid metal material.

10. The vehicle according to claim 9, wherein the rigid metal material is steel.

11. A vehicle comprising:
a frame including a first longitudinally extending rail and a second longitudinally extending rail;
an electric drive motor positioned between and supported by each of the first and second longitudinally extending rails;
a pump assembly attached to one of the first and second longitudinally rails at a location positioned forward of the electric drive motor;
a high-voltage component attached to a forward end and upper surface of the electric drive motor; and
a protection shield attached to the forward end of the electric drive motor at a position forward and spaced apart from the high-voltage component, and between the high-voltage component and the pump assembly,
wherein the protection shield is configured to shield and deflect the pump assembly from contacting the high-voltage component when the pump assembly is forced in a direction toward the high-voltage component during a frontal collision of the vehicle.

12. The vehicle according to claim 11, wherein the protection shield includes a primary panel including an upper section and a lower section.

13. The vehicle according to claim 12, wherein the upper section is connected to the lower section by a connection section, and the upper section is acutely angled relative to the lower section such that the connection section operates as a hinge that permits the upper section to pivot relative to the lower section when contacted by the pump assembly during the frontal collision.

14. The vehicle according to claim 13, wherein the primary panel includes a first side section that defines a lip and a second side section that includes secondary panel extending outward therefrom.

15. The vehicle according to claim 14, wherein the secondary panel includes a plurality of apertures configured for receipt of a first fastener that secures the protection shield to the electric drive motor.

16. The vehicle according to claim 15, wherein the lower section includes a rearwardly extending flange that includes an aperture configured for receipt of a second fastener that secures the protection shield to the electric drive motor.

17. The vehicle according to claim 11, further comprising an electric cable provided proximate the high-voltage component, wherein the protection shield is configured to shield and deflect the pump assembly that is forced in a direction toward the electric cable during the frontal collision.

18. The vehicle according to claim 11, wherein the protection shield is formed of a rigid metal material.

19. The vehicle according to claim 18, wherein the rigid metal material is steel.
